(19) United States
(12) Patent Application Publication
(10) Pub. No.: US 2017/0060281 A1
(43) Pub. Date: Mar. 2, 2017

(54) SUBSTRATE, METHOD FOR MANUFACTURING THE SAME AND DISPLAY DEVICE

(71) Applicants: BOE TECHNOLOGY GROUP CO., LTD., Beijing (CN); HEFEI XINSHENG OPTOELECTRONICS TECHNOLOGIES CO., LTD., Anhui (CN)

(72) Inventors: Xiaodong XIE, Beijing (CN); Ming HU, Beijing (CN); Ming ZHANG, Beijing (CN); Juntao CHEN, Beijing (CN); Jian TIAN, Beijing (CN)

(73) Assignees: BOE TECHNOLOGY GROUP CO., LTD., Beijing (CN); HEFEI XINSHENG OPTOELECTRONICS TECHNOLOGY CO., LTD., Anhui (CN)

(21) Appl. No.: 15/098,429

(22) Filed: Apr. 14, 2016

(30) Foreign Application Priority Data
Aug. 26, 2015 (CN) 201510531149.7

(51) Int. Cl. G06F 3/041

(52) U.S. Cl. CPC G06F 3/041; G06F 2203/04103

(57) ABSTRACT

The present disclosure relates to the field of display technology, and provides a substrate, a method for manufacturing the same and a display device. The substrate includes a signal line and a GND line configured to remove static charges on the signal line.

### CROSS-REFERENCE TO RELATED APPLICATION

The present application claims a priority of the Chinese patent application No. 201510531149.7 filed on Aug. 26, 2015, which is incorporated herein by reference in its entirety.

### TECHNICAL FIELD

The present disclosure relates to the field of display technology, in particular to a substrate, a method for manufacturing the same and a display device.

### BACKGROUND

Usually, a signal line on a display substrate for a signal transmission is of a relatively small width, e.g., 30 μm, 25 μm or 20 μm. When a high static electricity voltage is applied to the signal line, the signal line may be subjected to an electrostatic breakdown, and thereby the signal line may be broke and then the signal cannot be transmitted via the signal line. Hence, in order to prevent the occurrence of electrostatic breakdown, usually a ground (GND) line is arranged at a periphery of the display substrate, so as to remove static charges rapidly.

Generally, the GND line has a width of 300 μm to 40 μm. Of course, the larger the width of the GND line, the better. In this way, a resistance of the GND line may be low, so as to remove the static charges rapidly. However, when the GND line is of a large width, there is such a risk that the GND line may not be firmly attached onto an organic insulating material, and even the GND line may fall off from the organic insulating material. As a result, it is impossible to rapidly remove the static charges on the signal line. At this time, the signal line may be broken down by the static electricity and then broken.

### SUMMARY

An object of the present disclosure is to provide a substrate, a method for manufacturing the same and a display device, so as to prevent the GND line from falling off when the resistance of the GND line on the substrate is reduced by increasing its width.

In one aspect, the present disclosure provides in some embodiments a substrate, including a signal line, and a GND line configured to remove static charges on the signal line and including a plurality of hollowed-out regions.

In another aspect, the present disclosure provides in some embodiments a display device including the above-mentioned substrate.

In yet another aspect, the present disclosure provides in sonic embodiments a method for manufacturing a substrate, including steps of forming a signal line and a GND line configured to remove static charges on the signal line. The step of forming the GND line includes forming a plurality of hollowed-out regions in the GND line.

According to the embodiments of the present disclosure, through the hollowed-out regions in the GND line, it is able to attach the GND line firmly onto a target material while guaranteeing a certain width of the GND line and reducing the resistance thereof, and rapidly remove the static charges accumulated on the signal line, thereby to guarantee the performance of the substrate and improve the display quality of the display device.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1a is a schematic view showing a GND line according to some embodiments of the present disclosure;

FIG. 1b is a schematic view showing a connection mode for a GND line and a signal line according to some embodiments of the present disclosure;

FIG. 2 is a schematic view showing a GND line according to some embodiments of the present disclosure;

FIG. 3 is a schematic view showing a GND line according to sonic embodiments of the present disclosure;

FIG. 4 is a schematic view showing a GND line according to some embodiments of the present disclosure;

FIG. 5 is a schematic view showing a GND line according to some embodiments of the present disclosure;

FIG. 6 is a schematic view showing a GND line according to some embodiments of the present disclosure;

FIG. 7 is a schematic view showing a GND line according to sonic embodiments of the present disclosure;

FIG. 8a is a schematic view showing a GND sub-line according to some embodiments of the present disclosure;

FIG. 8b is a schematic view showing a planarization layer according to some embodiments of the present disclosure;

FIG. 8c is a schematic view showing another GND sub-line according to some embodiments of the present disclosure; and

FIG. 9 is a sectional view of the substrate along line A-A after the formation of the GND sub-line in FIG. 8a, the planarization layer in FIG. 8b and the GND sub-line in FIG. 8c.

### DETAILED DESCRIPTION OF THE EMBODIMENTS

During the manufacture of a substrate, e.g., an array substrate or a color filter substrate, static charges may be introduced. When a high static electricity voltage is applied to a signal line, the signal line may be subjected to an electrostatic breakdown and then broken. As a result, it is impossible to transmit a signal via the signal line, and the property of the substrate may be adversely affected. In order to overcome this drawback, usually a GND line is arranged at a periphery of the substrate. The static charges accumulated on the signal line may be removed by connecting the GND to the signal line, or by point discharging. When the resistance of the GND line is low, the static charges may be removed rapidly via the GND line. In the related art, a width of the GND line is increased so as to reduce its resistance. However, when its width is increased, it is difficult to attach the GND line to the target material firmly, i.e., the GND line may easily fall off from the target material.

The present disclosure provides in some embodiments a substrate and a method for manufacturing the same, so as to ensure the firm attachment of the GND line to the target material while reducing the resistance of the GND line, thereby to prevent the GND line from falling off from the target material.

The method for manufacturing a substrate includes a step of forming a plurality of hollowed-out regions in a GND line to make the formed substrate have a plurality of hollowed-out regions, so as to reduce a width of a portion of the GND line corresponding to each hollowed-out region. As a result, it is able to attach the GND line to a target material firmly, thereby to prevent the GND line from falling off therefrom.

The present disclosure will be described hereinafter in conjunction with the drawings and embodiments. The following embodiments are for illustrative purposes only, but shall not be used to limit the scope of the present disclosure.

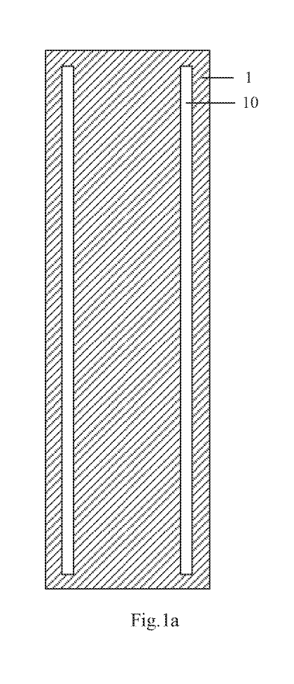

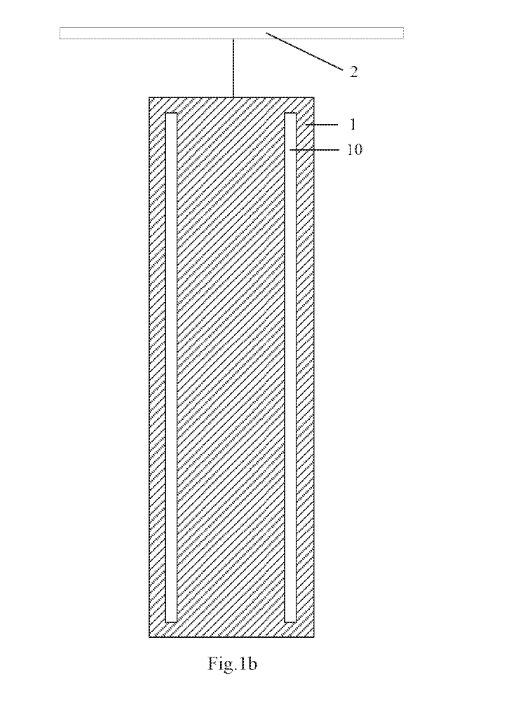

As shown in FIGS. 1a-7, the substrate in some embodiments of the present disclosure includes a signal line 2 and a GND line 1. Static charges on the signal line 2 may be removed by connecting the GND line 1 to the signal line 2, or by point discharging. FIG. 1b shows a connection mode for the GND line 1 and the signal line 2. By arranging the hollowed-out region 10 at a certain region of the GND line 1, an area of the GND line 1 at the certain region may be reduced, thereby improving the attachment of the GND line 1 at the certain region to the target material, thereby to prevent the GND line 1 from falling off therefrom. In addition, when the GND line 1 includes the hollowed-out regions 10, its width may be increased appropriately, so as to reduce its resistance and remove the static charges more rapidly.

The GND line 1 may be made of Cu, Al, Ag, Mo, Cr, Nd, Ni, Mn, Ti, Ta, W or an alloy thereof (e.g., Mo—Al—Mo).

According to the solution in the embodiments of the present disclosure, through the hollowed-out regions 10 arranged in the GND line 1, it is able to improve the attachment of the GND line 1 to the target material while reducing its resistance.

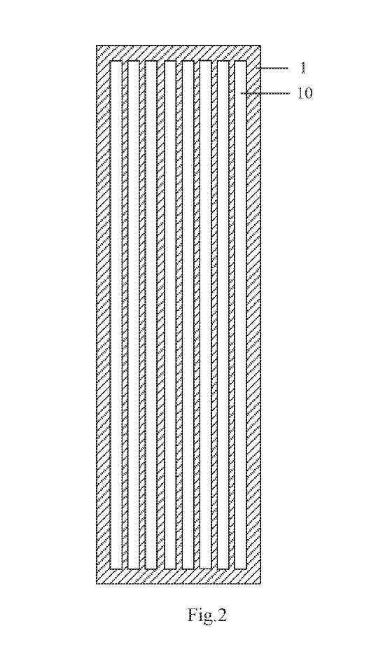

In some embodiments of the present disclosure, each hollowed-out region 10 may extend from one end of the GND line 1 to the other end thereof, as shown in FIGS. 1-2.

In some embodiments of the present disclosure, the hollowed-out regions 10 are spaced apart from each other in an extension direction of the GND line 1. As compared with the situation where the hollowed-out region 10 extends from one end of the GND line 1 to the other end thereof, it is able to further improve the attachment of the GND line 1 to the target material while reducing its resistance. In other words, it is able to make a compromise between the reduction of the resistance and the improvement of the firm attachment.

When the GND line 1 extends in a column direction, the GND line 1 may include the hollowed-out regions 10 arranged in at least one column. In each column, the hollowed-out regions 10 are spaced apart from each other, so as to reduce the resistance of the GND line 1. During the actual application, the hollowed-out regions 10 may be arranged in one or two columns, depending on the width of the GND line 1. Alternatively, the hollowed-out regions 10 may be arranged in two columns, so as to significantly improve the attachment of the GND line 1 to the target material.

In order to simplify the manufacture process, in some embodiments of the present disclosure, the hollowed-out regions 10 in the GND line 1 are of an identical shape, including but not limited to a polygon, a circle or an ellipse. For example, each hollowed-out region 10 may be polygonal, as shown in FIGS. 1-7.

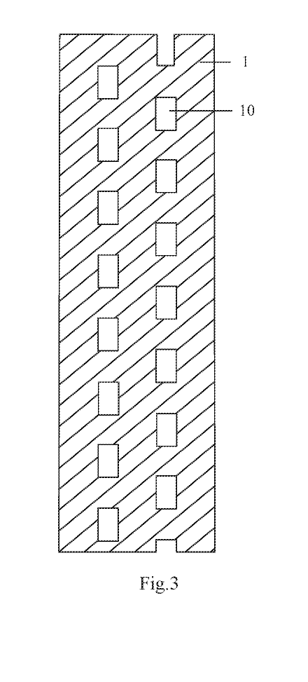

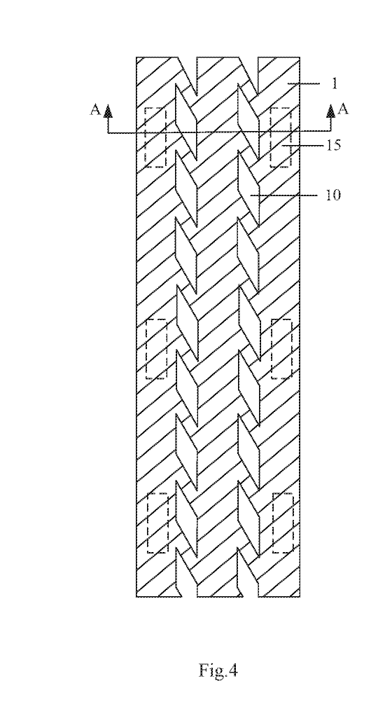

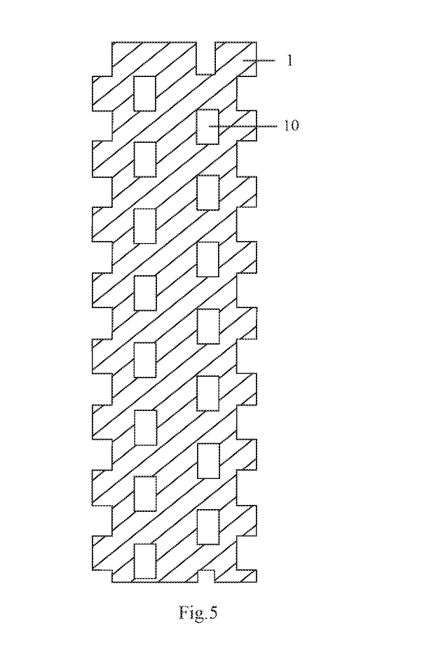

Further, the GND line 1 may be straight edges, as shown in FIGS. 3-4, so as to reduce a length of the GND line 1, thereby to reduce its resistance. Of course, the GND line 1 may also be of broken line edges, curved edges or the like. As shown in FIG. 5, the GND line 1 is of broken line edges.

Obviously, the more the hollowed-out regions in the GND line 1, the more firmly the GND line 1 will be attached to the target material and the larger the resistance of the GND line 1 will be. In order to make a compromise between the resistance and the firm attachment of the GND line 1, the resistance of the GND line 1 will be tested in various embodiments through simulation. In these embodiments, the GND lines 1 are of an identical length and an identical maximum width, and the hollowed-out regions 10 are of an identical shape.

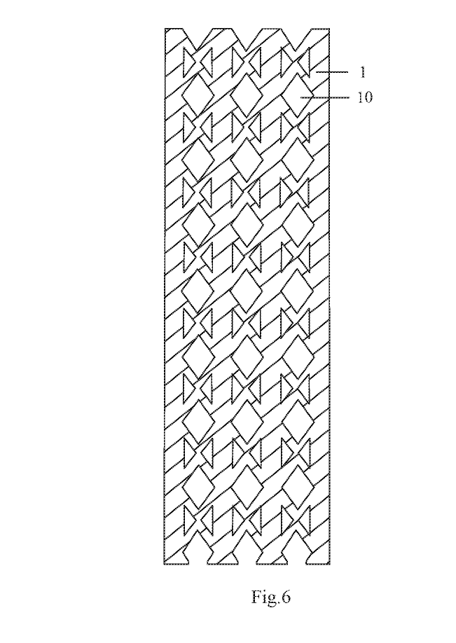

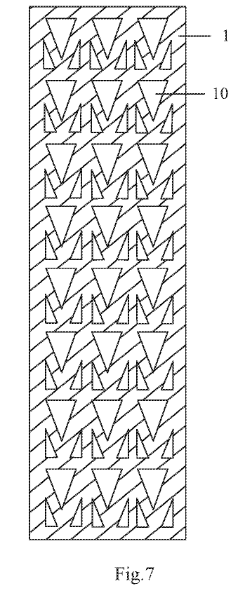

in FIG. 1, the GND line 1 is of straight edges and includes two hollowed-out regions 10 which each extend from one end of the GND line 1 to the other end thereof. In FIG. 2, the GND line 1 is of straight edges and includes eight hollowed-out regions 10 which each extend from one end of the GND line 1 to the other end thereof. In FIG. 3, the GND line 1 is of straight edges and includes the hollowed-out regions 10 arranged in two columns. In each column, the hollowed-out regions 10 are spaced apart from each other, and each hollowed-out region 10 is rectangular. In FIG. 6, the GND line 1 is of straight edges and includes the hollowed-out regions 10 arranged in two columns. In each column, the hollowed-out regions 10 are spaced apart from each other, and each hollowed-out region 10 is a parallelogram, In FIG. 5, the GND line 1 is of broken line edges and includes the hollowed-out regions 10 arranged in two columns. In each column, the hollowed-out regions 10 are spaced apart from each other, and each hollowed-out region 10 is rectangular. In FIG. 6, the GND line 1 is of straight edges and includes the hollowed-out regions 10 arranged in three columns. In each column, the hollowed-out regions 10 are spaced apart from each other, and each hollowed-out region 10 includes one rhombic portion and two triangular portions. In FIG. 7, the GND line 1 is of straight edges and includes the hollowed-out regions 10 arranged in three columns. In each column, the hollowed-out regions 10 are spaced apart from each other, and each hollowed-out region 10 includes one relatively large triangular portion and two relatively small triangular portions.

When the GND line 1 has a length of 40 mm and a square resistance Rs is 0.3 Ω/□, the resistances of the GND lines 1 in FIGS. 1-7 are 343Ω, 590Ω, 380Ω, 420Ω, 482Ω, 555Ω and 540Ω respectively through simulation. When the GND line 1 is not provided any hollowed-out region 10, its resistance is 3000Ω. The simulation test for the resistance of the GND line 1 and the simulation test for the attachment thereof show that, the GND lines 1 in FIGS. 3 and 4 have a better effect in both preventing the occurrence of electrostatic breakdown and preventing the GND lines 1 from falling off from the target material.

Based on the above-mentioned simulation results, alternatively, the GND line 1 may include the hollowed-out regions 10 arranged in two columns, each hollowed-out region 10 may be polygonal and the GND line 1 may be of straight edges. In this way, it is able for the GND line 1 to make a compromise between the low transmission resistance and the firm attachment, thereby to achieve a better effect in both preventing the occurrence of electrostatic breakdown and preventing the GND lines 1 from falling off from the target material.

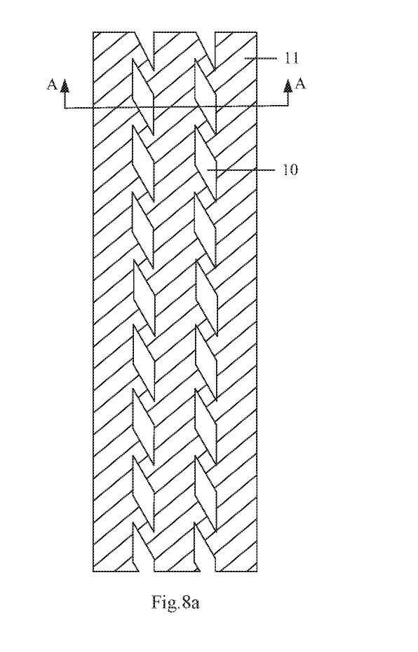

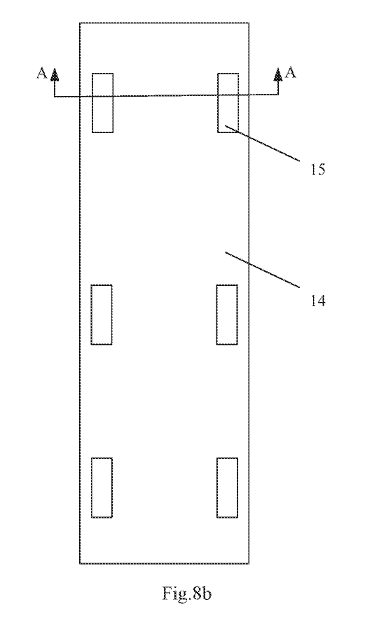

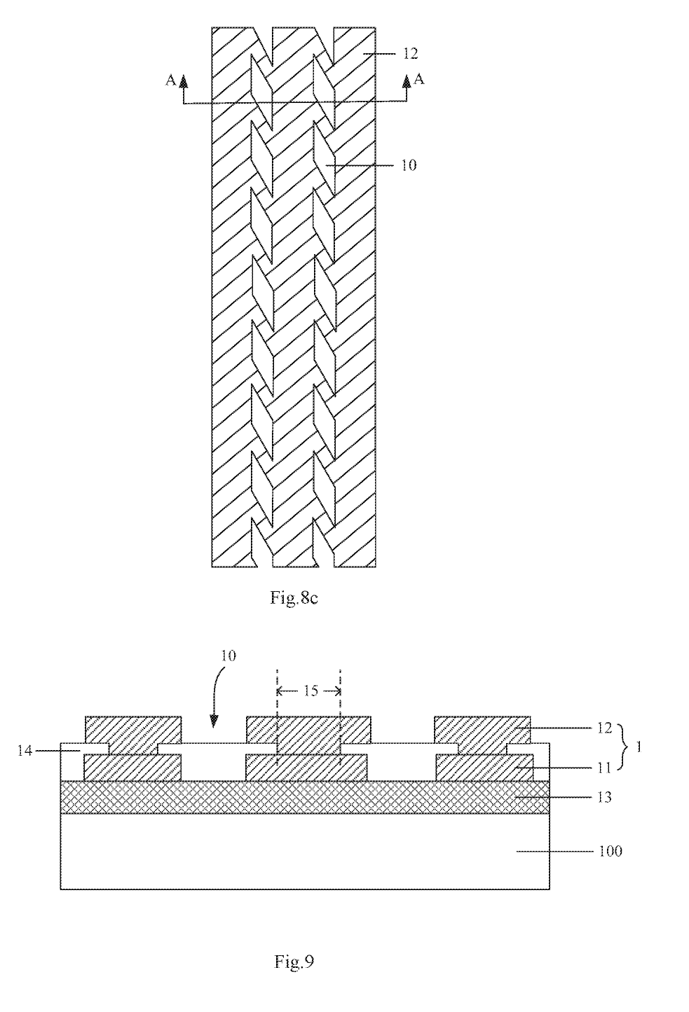

In order to further reduce the resistance of the GND line 1, alternatively, the GND line 1 may include at least two GND sub-lines connected in parallel (e.g., the GND sub-lines 11, 12 in FIG. 8), so that the resistance of the GND line 1 is lower than the resistance of any one of the GND sub-lines 11, 12, as shown in FIGS. 8a, 8c and 9. The at least two GND sub-lines 11, 12 are arranged at different layers, and each GDN sub-line includes a plurality of hollowed-out regions 10 therein. Through the hollowed-out regions 10, it is able to improve the attachment of each GND sub-line to the target material. In this case, the width of the GND sub-line 11, 12 may be increased appropriately, so as to reduce the resistance of each GND sub-line and then reduce the resistance of the GND line 1, thereby to remove the static charges rapidly and prevent the GND sub-lines 11, 12 from falling off from the target material.

It should be appreciated that, the GND line 1 in FIGS. 1a-3 and 5-7 may also include at least two GND sub-lines connected in parallel.

To be specific, a planarization layer 14 may be arranged between the GND sub-lines 11, 12, and the GND sub-lines 11, 12 may be electrically connected to each other in parallel through via-holes 15 in the planarization layer 14, as shown in FIGS. 8b and 9. The planarization layer 14 provides a flat surface for the GND sub-lines.

The hollowed-out regions 10 in the GND sub-lines 11, 12 may each extend from one end of the GND sub-line to the other end thereof.

In some embodiments of the present disclosure, the hollowed-out regions 10 are spaced apart from each other in an extension direction of the GND sub-line. As compared with the situation where the hollowed-out region 10 extends from one end of the GND sub-line to the other end thereof, it is able to further improve the attachment of the GND sub-lines 11, 12 to the target material while reducing the resistances of the GND sub-lines 11, 12. In other words, it is able to make a compromise between the resistance of the GND line 1 and the attachment thereof.

When the GND sub-line extends in a column direction, the GND sub-line may include the hollowed-out regions 10 arranged in at least one column. In each column, the hollowed-out regions 10 are spaced apart from each other, so as to reduce the resistance of the GND sub-line. During the actual application, the hollowed-out regions 10 may be arranged in one or two columns, depending on the width of the GND sub-lines 11, 12. Alternatively, the hollowed-out regions 10 may be arranged in two columns, so as to significantly improve the attachments of the GND sub-lines 11, 12 to the target material.

The number of the columns of the hollowed-out regions 10, the number of the hollowed-out regions 10 in each column, and the shapes thereof may be identical or different

In order to simplify the manufacture process, in some embodiments of the present disclosure, the hollowed-out regions 10 in the GND sub-lines 11, 12 are of an identical shape, including but not limited to a polygon, a circle or an ellipse.

Furthermore, the GND sub-lines 11, 12 may each be of straight edges, so as to reduce the length and the resistances thereof. Of course, the GND sub-lines 11, 12 may each be of broken line edges, curved edges or the like.

In some embodiments of the present disclosure, the GND line 1 includes at least two GND sub-lines 11, 12 connected in parallel. The at least two GND sub-lines 11, 12 are arranged at different layers, and each GND sub-line includes a plurality of hollowed-out regions 10. Each GND sub-line includes the hollowed-out regions 10 arranged in two columns, and the hollowed-out regions 10 are spaced apart from each other in a column direction. All the hollowed-out regions are of an identical shape, e.g., a rectangle or a rhombus. Each GND sub-line may be of straight edges.

In some embodiments of the present disclosure, the GND line 1 is of a single-layered structure and includes the hollowed-out regions 10 arranged in two columns. In the column direction, the hollowed-out regions 10 are spaced apart from each other. All the hollowed-out regions 10 are of an identical shape, e.g., a rectangle or a rhombus. The GND line 1 is of straight edges.

In some embodiments of the present disclosure, the substrate may be a touch substrate or a display substrate.

The structure of the substrate will be described hereinafter by taking the touch substrate as an example. The touch substrate includes a touch region and a peripheral region surrounding the touch region, and the GND line 1 is located at the peripheral region.

When the GND line 1 includes two GND sub-lines connected in parallel, as shown in FIGS. 8a-8c and 9, the touch substrate includes: a base substrate 100, which is usually a tramp one, e.g., a glass substrate, an organic resin substrate or a quartz substrate; a black matrix 13 arranged on the base substrate 100 and at the peripheral region; a first GND sub-line 11 arranged on the black matrix 13; a planarization layer 14 covering the first GND sub-line 11, including at least two via-holes 15, and a second GND sub-line 12 arranged on the planarization layer 14, where the second GND sub-line 12 is connected in parallel to the first GND sub-line 11 through the via-holes 15 arranged in the planarization layer 14. The first GND sub-line 11 and the second GND sub-line 12 each includes a plurality of hollowed-out regions 10. The structures and the arrangement modes of the hollowed-out regions 10 have been described hereinabove, and the description thereof is omitted herein.

When the GND line 1 is of a single-layered structure, the touch substrate includes a base substrate 100, a black matrix 13 arranged on the base substrate 100 and at the peripheral region, a planarization layer 14 covering the black matrix 13 and the GND line 1 arranged on the planarization layer 14 and at the peripheral region. The GND line 1 includes a plurality of hollowed-out regions 10. The structures and the arrangement modes of the hollowed-out regions 10 have been described hereinabove, and the description thereof is omitted herein.

The present disclosure further provides in some embodiments a display device including the above-mentioned substrate. During the manufacture, it is able to rapidly remove the static charges accumulated on the signal line, thereby to guarantee the performance of the substrate and improve the display quality of the display device.

The display device may be a liquid crystal display device, an organic light-emitting diode (OLED) display device, a touch display device, or the like. To be specific, the display device may be any product or component having a display function, such as a display panel, an electronic paper, an OLED panel, a mobile phone, a flat-panel computer, a television, a display, a laptop computer, a digital photo frame or a navigator.

On the basis of an identical inventive concept, the present disclosure further provides in some embodiments a method for manufacturing a substrate, including steps of forming a signal line and a GND line configured to remove static charges on the signal line. The step of forming the GND line includes forming a plurality of hollowed-out regions in the GND line.

By arranging the hollowed-out region at a certain region of the GND line, an area of the GND line at the certain region may be reduced, thereby improving the attachment of the GND line at the certain region to the target material and preventing the GND line from falling off therefrom. In addition, the width of the GND line may be increased appropriately, so as to reduce the resistance of the GND line and remove the static charges more rapidly.

Due to the hollowed-out regions, the resistance of the GND line will be increased inevitably. In order to reduce the resistance of the GND line, alternatively, the GND line may include at least two GND sub-lines connected in parallel. In this case, the step of forming the GND line includes forming at least two GND sub-lines connected in parallel, and forming a plurality of hollowed-out regions in each GND sub-line.

A total resistance of two resistors connected in parallel is less than the resistance of any one of the resistors. Through the at least two GND sub-lines connected in parallel, it is able to reduce the total resistance of the GND line, thereby to remove the static charges more rapidly. In addition, each GND sub-line includes a plurality of hollowed-out regions, so it is able to improve the attachment of the GND sub-lines to the target material, thereby to prevent the GND sub-lines from falling off therefrom.

The structures and the arrangement modes of the hollowed-out regions have been described hereinabove, and the description thereof is omitted herein.

In some embodiments of the present disclosure, the substrate may be a touch substrate or a display substrate.

A manufacture procedure for the substrate in some embodiments of the present disclosure will be described hereinafter by taking the touch substrate as an example. The touch substrate includes a touch region and a peripheral region surrounding the touch region, and the GND line is arranged at the peripheral region.

When the GND line includes two GND sub-lines connected in parallel, the method for manufacturing the touch substrate includes steps of: providing a base substrate; forming a black matrix on the base substrate and at the peripheral region; forming a first GND sub-line on the black matrix; forming a planarization layer covering the first GND sub-line and forming at least two via-holes in the planarization layer; and forming on the planarization layer a second GND sub-line which is connected in parallel to the first GND sub-line through the via-holes in the planarization layer. The touch substrate may be obtained through the above-mentioned steps.

The step of forming the first GND sub-line (or the second GND sub-line) includes patterning the first GND sub-line (or the second GND sub-line), so as to form a plurality of hollowed-out regions therein. The patterning process includes applying, exposing, developing, etching and washing a photoresist. The planarization layer may be made of organic resin.

When the GND line is of a single-layered structure, the method for manufacturing the touch substrate includes steps of: providing a base substrate; forming a black matrix on the base substrate and at the peripheral region; forming a planarization layer covering the black matrix; and forming the GND line on the planarization layer and at the peripheral region. The touch substrate may be manufactured through the above-mentioned steps.

The step of forming the GND line includes patterning the GND line so as to form a plurality of hollowed-out regions therein.

When the static charges accumulated on the signal line is removed by connecting the GND line to the signal line, it is necessary to disconnect the GND line from the signal line after the manufacture of the substrate is completed. To be specific, for a liquid crystal display substrate,after an array substrate and a color filter substrate are arranged opposite to each other to form a cell, a peripheral region of a display substrate may be removed, so as to disconnect the GND line form the signal line. The display substrate includes a display region and a non-display region surrounding the display region. A surrounding region of the display substrate is a new added region located at a periphery of the non-display region. When the touch substrate and the display substrate have been arranged opposite to each other to form a cell, the peripheral region of the touch substrate may be removed, so as to disconnect the GND line from the signal line.

The above are merely the preferred embodiments of the present disclosure. It should be appreciated that, a person skilled in the art may make further modifications and improvements without departing from the principle of the present disclosure, and these modifications and improvements shall also fall within the scope of the present disclosure.

What is claimed is:

1. A substrate, comprising a signal line and a ground (GND) line configured to remove static charges on the signal line, wherein the GND line comprises a plurality of hollowed-out regions.

2. The substrate according to claim 1, wherein the GND line comprises at least two GND sub-lines connected in parallel and arranged at different layers, and each GND sub-line comprises a plurality of hollowed-out regions.

3. The substrate according to claim 2, wherein the plurality of hollowed-out regions is spaced apart from each other in an extension direction of the GND line.

4. The substrate according to claim 3, wherein the GND line is of straight edges.

5. The substrate according to claim 3, the GND line comprises the hollowed-out regions arranged in two columns and along the extension direction of the GND line.

6. The substrate according to claim 3, wherein the hollowed-out regions are of an identical shape.

7. The substrate according to claim 3, wherein the hollowed-out regions are each of a polygonal, circular or elliptical shape.

8. The substrate according to claim 2, wherein the substrate is a touch substrate comprising a touch region and a peripheral region surrounding the touch region, the GND line comprises a first GND sub-line and a second GND sub-line connected in parallel and located at the peripheral region, and
the substrate comprises:
a base substrate;
a black matrix arranged on the base substrate and at the peripheral region;
the first GND sub-line arranged on the black matrix;
a planarization layer covering the first GND sub-line and comprising at least two via-holes; and
the second GND sub-line arranged on the planarization layer and connected in parallel to the first GND sub-line through the via-holes in the planarization layer.

9. The substrate according to claim 1, wherein the substrate is a touch substrate comprising a touch region and a peripheral region surrounding the touch region, and
the substrate comprises:
a base substrate;
a black matrix arranged on the base substrate and at the peripheral region;
a planarization layer covering the black matrix and
the GND line arranged on the planarization layer located at the peripheral region.

10. The substrate according to claim 1, wherein the substrate is a display substrate.

11. A display device comprising the substrate according to claim

12. A method for manufacturing a substrate, comprising steps of forming a signal line and a ground (GND) line configured to remove static charges on the signal line, wherein the step of forming the GND line comprises forming a plurality of hollowed-out regions in the GND line.

13. The method according to claim 12, wherein the step of forming the GND line comprises forming at least two GND sub-lines connected in parallel, and forming the plurality of hollowed-out regions in each GND sub-line.

14. The method according to claim 13, wherein the substrate is a touch substrate comprising a touch region and a peripheral region surrounding the touch region, the GND line comprises a first GND sub-line and a second GND sub-line connected in parallel and arranged at the peripheral region, and
the method comprises steps of:
providing a base substrate;
forming a black matrix on the base substrate and at the peripheral region;
forming the first GND sub-line on the black matrix;
forming a planarization layer covering the first GND sub-line, and forming at least two via-holes in the planarization layer; and
forming the second GND sub-line on the planarization layer, the second GND sub-line being connected in parallel to the first GND sub-line through the via-holes in the planarization layer.

15. The method according to claim 12, wherein the substrate is a touch substrate comprising a touch region and a peripheral region surrounding the touch region, and
the method comprises steps of:
providing a base substrate;
forming a black matrix on the base substrate and at the peripheral region;
forming a planarization layer covering the black matrix; and
forming the GND line on the planarization layer and at the peripheral region.

16. The method according to claim 14, wherein the step of forming the first GND sub-line comprises patterning the first GND sub-line to form the plurality of hollowed-out regions, a patterning process comprises applying, exposing, developing, etching and washing a photoresist, and a material of the planarization layer comprises organic resin.

17. The method according to claim 14, wherein the step of forming the second GND sub-line comprises patterning the second GND sub-line to form the plurality of hollowed-out regions, a patterning process comprises applying, exposing, developing, etching and washing a photoresist, and a material of the planarization layer comprises organic resin.

18. The method according to claim 14, wherein a material of the planarization layer comprises organic resin.

19. The substrate according to claim 8, wherein a projection of each via-hole onto the base substrate is located within a region where projections of the corresponding first GND sub-line and the corresponding second GND sub-line onto the base substrate are located.
